(19) United States
(12) Patent Application Publication
(10) Pub. No.: US 2018/0204547 A1
(43) Pub. Date: Jul. 19, 2018

(54) MUTE FOR A RECORDER

(71) Applicant: JUAREZ SALAS Francisco Jose, Sevilla (ES)

(72) Inventor: JUAREZ SALAS Francisco Jose, Sevilla (ES)

(21) Appl. No.: 15/742,500

(22) PCT Filed: Apr. 28, 2016
(86) PCT No.: PCT/ES2016/070320

§ 371 Date: Jan. 6, 2018

(30) Foreign Application Priority Data
Aug. 18, 2015 (ES) U201530954

(51) Int. Cl. G10D 9/06; G10D 7/02

(52) U.S. Cl. CPC G10D 9/06; G10D 7/023

(57) ABSTRACT

The present invention relates to a device which is introduced into the window of the mouthpiece, between the mouthpiece and the bevel, and which allows the volume of the sound produced by the recorder to be reduced, slightly affecting the quality of the sounds produced by same.

### OBJECT OF THE INVENTION

The object of the present invention is a device that is inserted in the window of the mouthpiece, between the mouthpiece and the bevel, and that allows to reduce the volume of the sound produced by the flute, slightly affecting the quality of the sounds it produces.

### BACKGROUND OF THE INVENTION

The interpreters of musical pieces need to repeatedly rehearse the pieces they have to perform, for this there are soundproofed enclosures or dedicated exclusively to this type of essays, in which the interpreter does not bother other people. This type of enclosures are usually used mainly by professionals. But in many occasions it is necessary that the rehearsals are developed in the private homes of the interpreters, especially when the interpreter is a student of a conservatory or a school or are self-taught, these rehearsals bother the neighbors because the piece or fragments thereof have to be repeated many times, because of the quality of the interpretation and of the volume of the music that can not be regulated.

The annoyances described in the previous paragraph have been borne by all those who have members of their family or neighbors who are learning or perfecting their interpretive technique with any musical instrument, especially with the recorder that is a cheap instrument and that occupies little space, for which is very used for the initiation in the music of children in schools.

The present invention provides a device that is coupled to a flute and that reduces the volume of the sounds produced by the flute, affecting slightly its sound quality, so that the flute can be played without disturbing the people nearby or the neighbors.

### BRIEF DESCRIPTION OF THE FIGURES

FIG. 1: shows a perspective view of the mute for recorder.

FIG. 2: shows a longitudinal section of a flute in which the mute for recorder has been coupled.

### DESCRIPTION OF THE INVENTION

The mute for recorder, object of the present invention, consists of a sheet that has removable fastening means to the mouth of the recorder, said sheet is intended to be inserted in the window of the recorder and its thickness is less than the length of the recorder window measured in the direction of the revolution axis of the recorder, the width of said sheet is less than the length of the sharp edge of the bevel of the recorder, and the length of the aforementioned sheet is greater than the radial distance between the outer surface of the recorder mouth and the sharp edge of the recorder bevel, and the face of said sheet intended to be facing the recorder mouth is convex from the point of view of said mouth.

### Preferred Embodiment

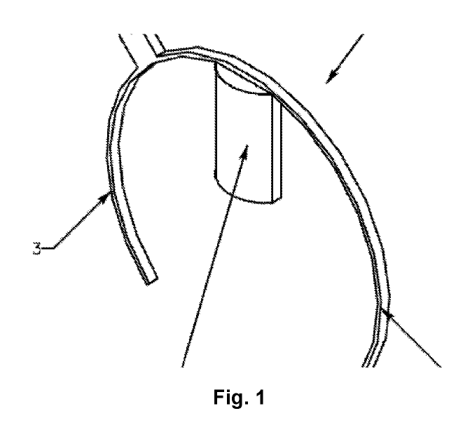

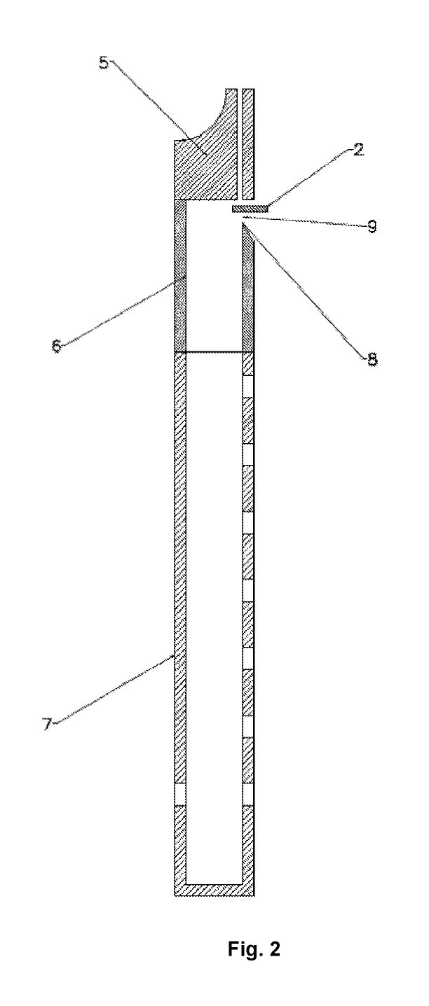

FIGS. 1 and 2 show a preferred embodiment of the mute (1) for recorder, object of the present description.

As is well known, a recorder produces sounds by striking a stream of air with a sharp edge, called a bevel (8), located in a window (9) arranged in the head (6), other elements of a recorder are the mouth (5) and the body (7), the different notes are achieved by plugging the holes of the body and therefore varying the properties of the air column inside the body, against which the blown air hits the mouth.

The mute (1) for recorder consists of a sheet (2) that has removable fixing means (3) to the recorder mouth, said sheet is intended to be inserted in the window (9) of the recorder, and its thickness is less than the length of the recorder window measured in the direction of the revolution axis of the recorder, the width of said sheet is less than the length of the sharp edge of the recorder bevel (9), and the length of said sheet is greater than the radial distance between the outer surface of the recorder mouth and the sharp edge of the recorder bevel, and the face of said sheet intended to be facing the recorder mouth is convex from the point of view of the mouth, so as to obtain the maximum reduction of the distortions in the produced sounds.

In a first design option, the removable fastening means (3) to the recorder mouth consist of two identical bands of semirigid material, and arranged symmetrically with respect to the longitudinal axis of the sheet, each of the bands has an approximate shape of an arc of circumference, and its length is less than half the length of the outer circumference of the recorder mouth, and to facilitate the coupling of the recorder mute, one or more of the bands may be provided with a handle.

1. Mute for recorder, characterized in that it consists of a convex sheet intended to be inserted in the recorder window, and two identical bands of semirigid material and arranged symmetrically with respect to the longitudinal axis of the sheet, each of the bands have an approximate shape of an arc of circumference and their length is less than half the length of the outer circumference of the recorder mouth.

2. Mute for recorder, according to claim 1, characterized in that one or more of the bands have a handle.
